(19) United States
(12) Patent Application Publication
(10) Pub. No.: US 2020/0399944 A1
(43) Pub. Date: Dec. 24, 2020

(54) VEHICLE SLIDE DOOR SUPPORT DEVICE

(71) Applicant: AISIN SEIKI KABUSHIKI KAISHA, Kariya-shi (JP)

(72) Inventors: Toshimitsu MORIOKA, Kariya-shi (JP); Taiki ISHIGURO, Kariya-shi (JP); Katsusuke ARAKI, Kariya-shi (JP)

(73) Assignee: AISIN SEIKI KABUSHIKI KAISHA, Kariya-shi (JP)

(21) Appl. No.: 16/902,431

(22) Filed: Jun. 16, 2020

(30) Foreign Application Priority Data
Jun. 18, 2019 (JP) 2019-112535
Sep. 17, 2019 (JP) 2019-168641

(51) Int. Cl. E05D 15/06; B60J 5/06

(52) U.S. Cl. CPC E05D 15/0656; E05D 15/0691; E05F 15/662; E05Y 2201/684; E05Y 2900/531; B60J 5/06

(57) ABSTRACT

A vehicle slide door support device connects a slide door to a vehicle body. The slide door is configured to open and close a door opening formed in a side surface of the vehicle body. The device includes: a first guide rail arranged on a lower portion of the slide door and regulating a movement direction of the slide door; a first hinge unit arranged below the door opening and configured to move relative to the first guide rail in a longitudinal direction of the first guide rail; a second guide rail arranged above the first hinge unit on the vehicle body and regulating the movement direction of the slide door; and a second hinge unit arranged above the first guide rail on the slide door and configured to move relative to the second guide rail in a longitudinal direction of the second guide rail.

### CROSS REFERENCE TO RELATED APPLICATIONS

This application is based on and claims priority under 35 U.S.C. §119 to Japanese Patent Application 2019-112535 and 2019-168641, filed on Jun. 18, 2019 and Sep. 17, 2019, respectively, the entire content of which is incorporated herein by reference.

### TECHNICAL FIELD

This disclosure relates to a vehicle slide door support device.

### BACKGROUND DISCUSSION

JP 2018-176980A (Reference 1) discloses a vehicle including a vehicle body having a door opening formed therein and a slide door which opens and closes the door opening. The vehicle body has an upper guide rail, a lower guide rail, and a center guide rail, each of which extends toward the front of the vehicle and is then curved inward in the vehicle width direction with a decreasing distance to the front of the vehicle. Meanwhile, the slide door has an upper guide roller unit connected to the upper guide rail, a lower guide roller unit connected to the lower guide rail, and a center guide roller unit connected to the center guide rail.

When the slide door is opened and closed, the upper guide roller unit, the lower guide roller unit, and the center guide roller unit move along the upper guide rail, the lower guide rail, and the center guide rail, respectively.

In the vehicle as described above, since the lower guide rail is arranged on a region below the door opening of the vehicle body, the region under the floor of a vehicle room is likely to become narrow. A need thus exists for a vehicle slide door support device which is not susceptible to the drawback mentioned above.

### SUMMARY

Hereinafter, means for achieving the above object and advantages thereof will be described.

A vehicle slide door support device according to an aspect of this disclosure connects a slide door to a vehicle body. The slide door is configured to open and close a door opening formed in a side surface of the vehicle body. The device includes a first guide rail arranged on a lower portion of the slide door and regulating a movement direction of the slide door, a first hinge unit arranged below the door opening and configured to move relative to the first guide rail in a longitudinal direction of the first guide rail, a second guide rail arranged above the first hinge unit on the vehicle body and regulating the movement direction of the slide door, and a second hinge unit arranged above the first guide rail on the slide door and configured to move relative to the second guide rail in a longitudinal direction of the second guide rail.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view schematically illustrating a vehicle according to a first embodiment;

FIG. 2 is a plan view of an upper rail and an upper hinge unit according to the first embodiment;

FIG. 3 is a plan view of a center rail and a center hinge unit according to the first embodiment;

FIG. 4 is a plan view of a lower rail and a lower hinge unit according to the first embodiment;

FIG. 5 is a plan view of the upper rail and the upper hinge unit according to the first embodiment;

FIG. 6 is a plan view of the center rail and the center hinge unit according to the first embodiment;

FIG. 7 is a plan view of the lower rail and the lower hinge unit according to the first embodiment;

FIG. 8 is a side view schematically illustrating the vehicle when the slide door according to the first embodiment is located near a fully closed position;

FIG. 9 is a plan view of a lower rail and a lower hinge unit according to a second embodiment;

FIG. 10 is a plan view of a guide unit according to the second embodiment as viewed from the top of the vehicle;

FIG. 11 is a rear view of the guide unit according to the second embodiment as viewed from the rear of the vehicle;

FIG. 12 is a plan view of the lower rail and the lower hinge unit according to the second embodiment;

FIG. 13 is a plan view of the lower rail and the lower hinge unit according to the second embodiment;

FIG. 14 is a plan view illustrating a relationship between the floor and the guide unit according to a first modification; and

FIG. 15 is a rear view illustrating a relationship between the floor and the guide unit according to a second modification.

### DETAILED DESCRIPTION

Hereinafter, an embodiment of a vehicle including a vehicle slide door support device (hereinafter also referred to as “slide door support device”) will be described. In the following description, the vehicle width direction is also simply referred to as “width direction,” the vehicle longitudinal direction is also simply referred to as “longitudinal direction,” and the vehicle vertical direction is also simply referred to as “vertical direction.”

### First Embodiment

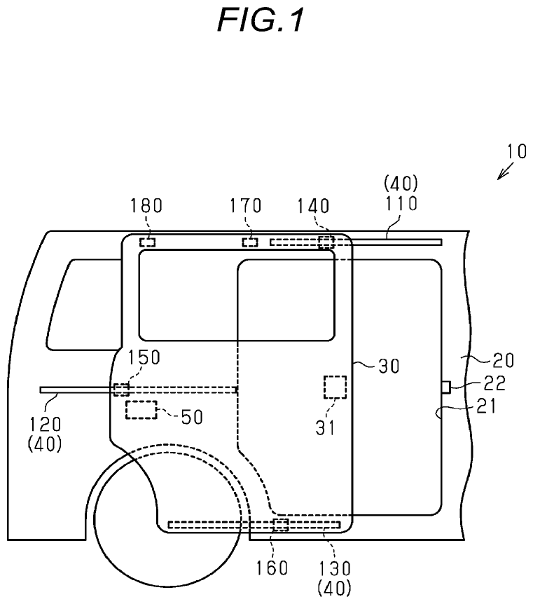

As illustrated in FIG. 1, a vehicle 10 includes a vehicle body 20 having a door opening 21 provided in a side portion thereof, a slide door 30 that opens and closes the door opening 21, a slide door support device 40 that connects the slide door 30 to the vehicle body 20, and a door actuator 50 that drives the slide door 30.

The vehicle body 20 has a striker 22 at the center in the vertical direction on the front end of the door opening 21. The striker 22 has a substantially U-shaped form and protrudes rearward.

The slide door 30 is opened and closed between a fully closed position where the door opening 21 is fully closed and a fully open position where the door opening 21 is fully opened. In the present embodiment, the slide door 30 is opened by moving rearward and is closed by moving forward. Further, the slide door 30 has a door lock device 31 that locks the slide door 30 at the fully closed position by being engaged with the striker 22 when the slide door 30 is located at the fully closed position.

The slide door support device 40 includes an upper rail 110 arranged above the door opening 21, a center rail 120 arranged behind the door opening 21, and a lower rail 130 arranged on a lower portion of the slide door 30. Further, the slide door support device 40 includes an upper hinge unit 140 arranged on an upper portion of the slide door 30, a center hinge unit 150 arranged on a rear portion of the slide door 30, and a lower hinge unit 160 arranged below the door opening 21. Furthermore, the slide door support device 40 includes a first engagement part 170 arranged above the door opening 21 and a second engagement part 180 arranged on the upper portion of the slide door 30.

In the present embodiment, the lower rail 130 corresponds to an example of a “first guide rail,” the lower hinge unit 160 corresponds to an example of a “first hinge unit,” the upper rail 110 corresponds to an example of a “second guide rail,” and the upper hinge unit 140 corresponds to an example of a “second hinge unit.”

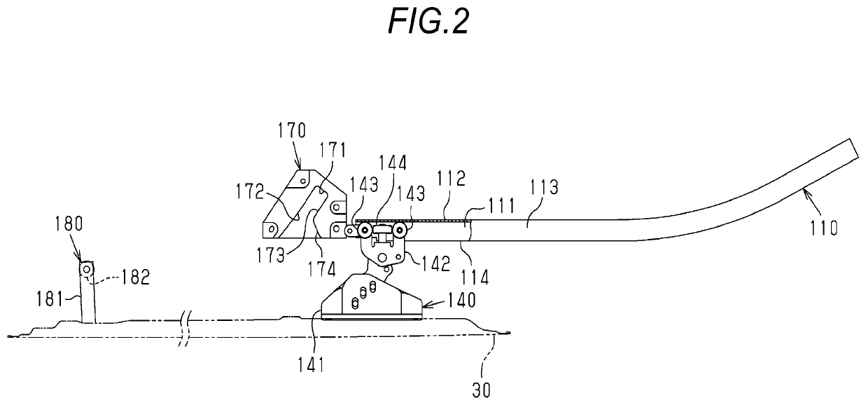

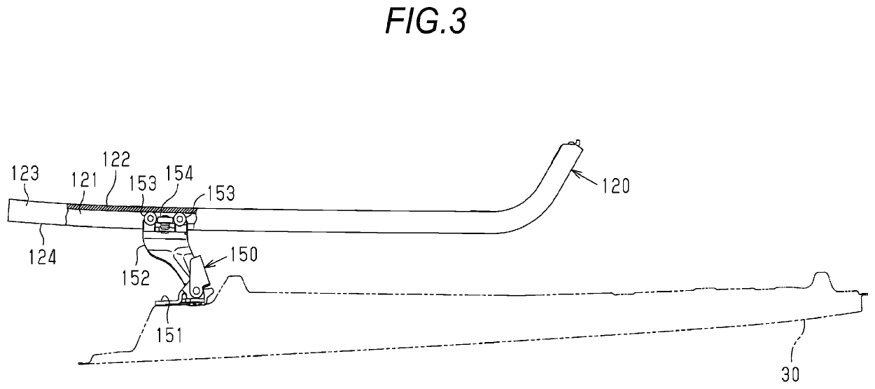

As illustrated in FIG. 1, the upper rail 110 and the center rail 120 are arranged on the side surface of the vehicle body 20. In the vertical direction, the upper rail 110 is arranged above the center rail 120 and the lower rail 130, and the center rail 120 is arranged between the upper rail 110 and the lower rail 130. As illustrated in FIGS. 2 and 3, the upper rail 110 and the center rail 120 extend forward and then, are curved so as to be directed inward in the width direction with a decreasing distance to the front.

As illustrated in FIG. 2, the upper rail 110 includes a bottom wall 111, a first sidewall 112 extending upward from the inner end in the width direction of the bottom wall 111, an upper wall 113 extending outward in the width direction from the upper end of the first sidewall 112, and a second sidewall 114 extending downward from the outer end in the width direction of the upper wall 113. Similarly, as illustrated in FIG. 3, the center rail 120 includes a bottom wall 121, a first sidewall 122 extending upward from the inner end in the width direction of the bottom wall 121, an upper wall 123 extending outward in the width direction from the upper end of the first sidewall 122, and a second sidewall 124 extending downward from the outer end in the width direction of the upper wall 123. That is, a part of the wall portion of the upper rail 110 and the center rail 120 that faces outward in the width direction is open.

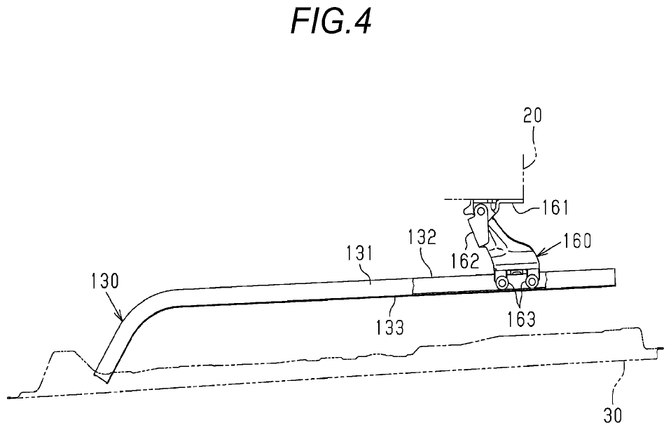

As illustrated in FIG. 4, the lower rail 130 is arranged inside the slide door 30 in the width direction. For example, the lower rail 130 is arranged between an inner panel and a door trim as components of the slide door 30. The lower rail 130 is curved so as to be directed inward in the width direction with a decreasing distance to the front and then, extends substantially forward. In other words, the lower rail 130 extends rearward and then, is curved so as to be directed outward in the width direction with a decreasing distance to the rear. That is, the lower rail 130 is curved in a manner different from the upper rail 110 and the center rail 120.

The lower rail 130 includes an upper wall 131, a first sidewall 132 extending downward from the inner end in the width direction of the upper wall 131, and a second sidewall 133 extending downward from the outer end in the width direction of the upper wall 131. That is, the lower rail 130 has a substantially C-shaped cross section orthogonal to the longitudinal direction. The cross-sectional shape of the lower rail 130 orthogonal to the longitudinal direction is open downward.

As illustrated in FIG. 2, the upper hinge unit 140 includes a bracket 141 fixed to the slide door 30, an arm 142 rotatably connected to the bracket 141, and a pair of guide rollers 143 and a load roller 144 rotatably supported by the arm 142.

In the upper hinge unit 140, the bracket 141 is fixed at a position close to the front end of the upper portion of the slide door 30. The arm 142 is connected to the bracket 141 so as to be rotatable around the axis extending in the vertical direction. The pair of guide rollers 143 are arranged side by side in a direction orthogonal to the vertical direction. The load roller 144 is arranged between the pair of guide rollers 143.

In a state where the upper hinge unit 140 is connected to the upper rail 110, the pair of guide rollers 143 are arranged between the first sidewall 112 and the second sidewall 114 of the upper rail 110, and the load roller 144 comes into contact with the bottom wall 111 of the upper rail 110. Then, when the upper hinge unit 140 moves in the longitudinal direction of the upper rail 110 with respect to the upper rail 110, the pair of guide rollers 143 rotate around the axis extending in the vertical direction in a state of being in contact with the first sidewall 112 or the second sidewall 114. Further, in this case, the load roller 144 rotates around the axis extending in a direction orthogonal to both the longitudinal direction and the vertical direction of the upper rail 110 in a state of being in contact with the bottom wall 111.

As illustrated in FIG. 3, the center hinge unit 150 includes a bracket 151 fixed to the slide door 30, an arm 152 rotatably connected to the bracket 151, and a pair of guide rollers 153 and a load roller 154 rotatably supported by the arm 152.

In the center hinge unit 150, the bracket 151 is fixed at a position close to the rear end of a central portion in the vertical direction of the slide door 30. The arm 152 is connected to the bracket 151 so as to be rotatable around the axis extending in the vertical direction. The pair of guide rollers 153 are arranged side by side in a direction orthogonal to the vertical direction. The load roller 154 is arranged between the pair of guide rollers 153.

In a state where the center hinge unit 150 is connected to the center rail 120, the pair of guide rollers 153 are arranged between the first sidewall 122 and the second sidewall 124 of the center rail 120, and the load roller 154 comes into contact with the bottom wall 121 of the center rail 120. Then, when the center hinge unit 150 moves in the longitudinal direction of the center rail 120 with respect to the center rail 120, the pair of guide rollers 153 rotate around the axis extending in the vertical direction in a state of being in contact with the first sidewall 122 or the second sidewall 124. Further, in this case, the load roller 154 rotates around the axis extending in a direction orthogonal to both the longitudinal direction and the vertical direction of the center rail 120 in a state of being in contact with the bottom wall 121.

As illustrated in FIG. 4, the lower hinge unit 160 includes a bracket 161 fixed to the door opening 21, an arm 162 rotatably connected to the bracket 161, and a pair of guide rollers 163 rotatably supported by the arm 162.

In the lower hinge unit 160, the bracket 161 is fixed behind and below the door opening 21. The arm 162 is connected to the bracket 161 so as to be rotatable around the axis extending in the vertical direction. The pair of guide rollers 163 are arranged side by side in a direction orthogonal to the vertical direction.

In a state where the lower hinge unit 160 is connected to the lower rail 130, the pair of guide rollers 163 are arranged between the first sidewall 132 and the second sidewall 133 of the lower rail 130. Then, when the lower hinge unit 160 moves relative to the lower rail 130 in the longitudinal direction of the lower rail 130, the pair of guide rollers 163 rotate around the axis extending in the vertical direction in a state of being in contact with the first sidewall 132 or the second sidewall 133.

In this way, in the upper hinge unit 140, the center hinge unit 150, and the lower hinge unit 160, the pair of guide rollers 143, 153 and 163 are positioned in the width direction of the slide door 30 with respect to the vehicle body 20. Further, in the upper hinge unit 140 and the center hinge unit 150, the load rollers 144 and 154 are positioned in the vertical direction of the slide door 30 with respect to the vehicle body 20. In this respect, it can be said that the load rollers 144 and 154 of the upper hinge unit 140 and the center hinge unit 150 support the weight of the slide door 30 so as to prevent the slide door 30 from falling.

As illustrated in FIG. 2, the first engagement part 170 is arranged behind and above the door opening 21, i.e., behind the upper rail 110. The first engagement part 170 has an accommodation groove 171 formed so as to be directed inward in the width direction with a decreasing distance to the front. The accommodation groove 171 has a first regulation surface 172 and a second regulation surface 173 extending in the depth direction of the accommodation groove 171 and a guide surface 174 connected to the second regulation surface 173 so as to intersect the second regulation surface 173. In a direction orthogonal to the depth direction of the accommodation groove 171, the distance between the first regulation surface 172 and the second regulation surface 173 is constant, and the distance between the first regulation surface 172 and the guide surface 174 gradually increases with a decreasing distance to the opening of the accommodation groove 171.

As illustrated in FIG. 2, the second engagement part 180 has a rod 181 extending inward in the width direction from the slide door 30 and an engagement roller 182 rotatably supported on the tip of the rod 181. The rod 181 is fixed at a position close to the rear end of the upper portion of the slide door 30. In this respect, the rod 181 is arranged at a distance in the longitudinal direction from the upper hinge unit 140. The outer diameter of the engagement roller 182 is less than the distance between the first regulation surface 172 and the second regulation surface 173 of the first engagement part 170. The engagement roller 182 is an example of an “engagement body” that enters the accommodation groove 171 of the first engagement part 170.

As illustrated in FIG. 1, the door actuator 50 is configured to include, for example, a motor driven by energization and a power transmission member that transmits power of the motor to the slide door 30. The power transmission member is, for example, a wire or a belt. In the present embodiment, the door actuator 50 is provided on the vehicle body 20, but the door actuator 50 may be provided on the slide door 30. Further, the door actuator 50 may be unitized with the center rail 120 and the center hinge unit 150, or may be unitized with the lower rail 130 and the lower hinge unit 160. The door actuator 50 closes the slide door 30 by applying a forward load to the slide door 30, and opens the slide door 30 by applying a rearward load to the slide door 30.

An operation of the present embodiment will be described.

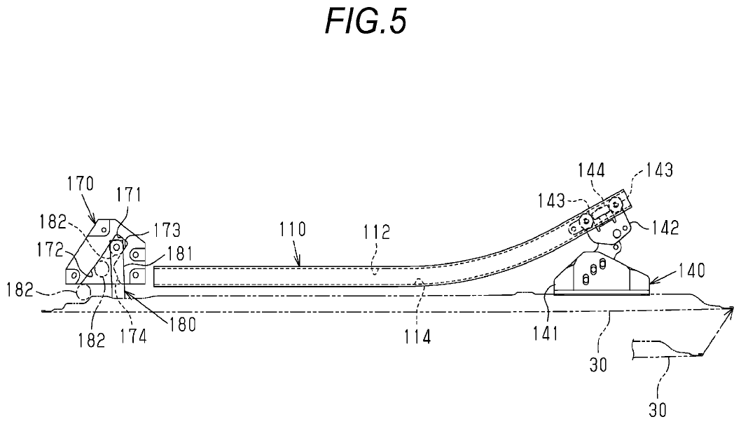

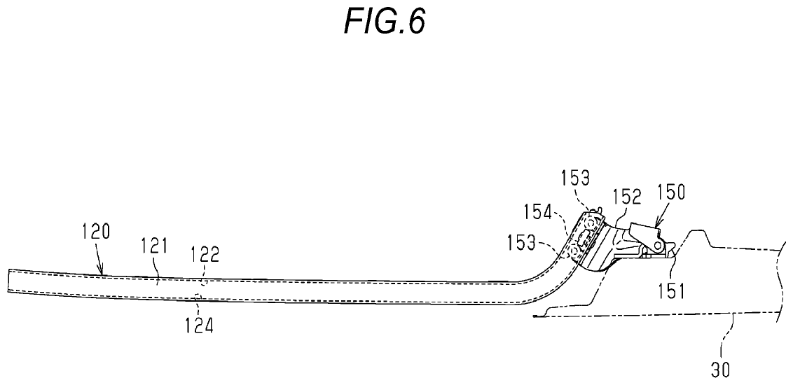

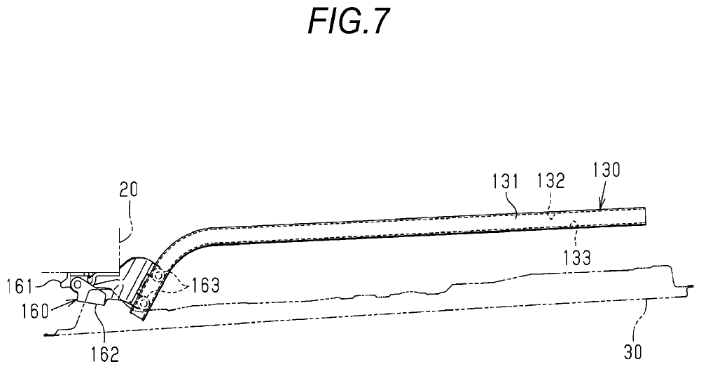

As illustrated in FIGS. 5 to 7, when the slide door 30 is closed by driving of the actuator, the upper hinge unit 140 moves forward with respect to the upper rail 110, the center hinge unit 150 moves forward with respect to the center rail 120, and the lower rail 130 moves forward with respect to the lower hinge unit 160.

Further, when the upper hinge unit 140 moves along a curved portion of the upper rail 110, the arm 142 rotates with respect to the bracket 141, and when the center hinge unit 150 moves along a curved portion of the center rail 120, the arm 152 rotates with respect to the bracket 151. Further, when a curved portion of the lower rail 130 moves with respect to the lower hinge unit 160, the arm 162 rotates with respect to the bracket 161. For this reason, the slide door 30 is closed with the front end thereof always facing forward and the rear end thereof always facing rearward.

When the slide door 30 comes closer to the fully closed position than the fully open position, in other words, when the slide door 30 moves to the vicinity of the fully closed position, the engagement roller 182 of the second engagement part 180 starts to enter the accommodation groove 171 in the first engagement part 170 as indicated by a two-dot dash line in FIG. 5. Here, as indicated by the one-dot dash line arrow in FIG. 5, since the accommodation groove 171 in the first engagement part 170 is formed along the movement path of the slide door 30, the engagement roller 182 provided on the tip of the rod 181 extending from the slide door 30 is guided to the accommodation groove 171 in the first engagement part 170 according to the closing operation of the slide door 30. Further, since the opening of the accommodation groove 171 is enlarged, the engagement roller 182 easily enters the accommodation groove 171.

When the engagement roller 182 enters the accommodation groove 171, the engagement roller 182 rotates in a state of being in contact with the first regulation surface 172 or the second regulation surface 173 of the accommodation groove 171. Then, when the slide door 30 further approaches the fully closed position, the engagement roller 182 of the second engagement part 180 is sandwiched between the first regulation surface 172 and the second regulation surface 173 in the width direction. That is, the upper portion of the rear end of the slide door 30 on which the second engagement part 180 is provided is restricted from moving in the width direction. Finally, when the slide door 30 is located at the fully closed position, as illustrated in FIG. 1, the door lock device 31 is engaged with the striker 22, and the slide door 30 is held at the fully closed position.

Effects of the present embodiment will be described.

(1) The slide door support device 40 does not need to include a guide rail below the door opening 21 in respect that it includes the lower hinge unit 160 below the door opening 21 and also includes the lower rail 130 provided on the lower portion of the slide door 30. Accordingly, the slide door support device 40 may suppress a region under the floor of a vehicle room from becoming narrow. As a result, for example, in an electric vehicle and a hybrid vehicle, the space in which a battery is loaded under the floor of a vehicle room becomes large.

(2) In a case where the lower hinge unit 160 is arranged below the door opening 21 and the lower rail 130 is arranged on the lower portion of the slide door 30, the posture of the slide door 30 when the slide door 30 is located near the fully closed position is likely to become unstable as compared with a case where the guide rail is arranged below the door opening 21 and the hinge unit is arranged on the lower portion of the slide door 30.

In this respect, the slide door support device 40 includes the first engagement part 170 and the second engagement part 180 which are engaged with each other when the slide door 30 is located near the fully closed position. Therefore, the slide door support device 40 may suppress the posture of the slide door 30 from becoming unstable when the slide door 30 is located near the fully closed position in respect that the number of connection sites between the vehicle body 20 and the slide door 30 is increased by the first engagement part 170 and the second engagement part 180.

(3) In the slide door support device 40, the first engagement part 170 is arranged above the door opening 21, and the upper hinge unit 140 and the second engagement part 180 are arranged on the upper portion of the slide door 30. Therefore, the slide door support device 40 may suppress the space under the floor of the vehicle room from becoming narrow in respect that the first engagement part 170 is not arranged below the door opening 21.

Further, since the upper hinge unit 140 and the second engagement part 180 are arranged at a distance therebetween in the longitudinal direction, when the slide door 30 is located near the fully closed position, the slide door support device 40 has connection sites between the vehicle body 20 and the upper portion of the slide door 30 which are spaced apart from each other in the longitudinal direction. Therefore, the slide door support device 40 may further suppress the posture of the slide door 30 from becoming unstable when the slide door 30 is located near the fully closed position.

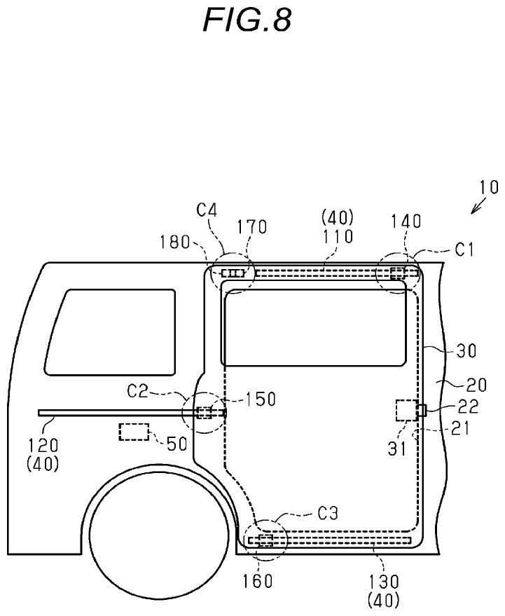

(4) FIG. 8 is a view illustrating connection sites between the vehicle body 20 and the slide door 30 when the slide door 30 is located near the fully closed position which are indicated respectively by two-dot dash lines. As illustrated in FIG. 8, the connection sites between the vehicle body 20 and the slide door 30 include a connection site C1 between the upper rail 110 and the upper hinge unit 140, a connection site C2 between the center rail 120 and the center hinge unit 150, a connection site C3 between the lower rail 130 and the lower hinge unit 160, and a connection site C4 between the first engagement part 170 and the second engagement part 180. That is, the slide door support device 40 does not support, on the vehicle body 20, only the regions of the slide door 30 that are deviated in the longitudinal direction and the vertical direction as viewed from the lateral side of the slide door 30. In this way, the slide door support device 40 may suppress the posture of the slide door 30 from becoming unstable when the slide door 30 is located near the fully closed position.

(5) The first engagement part 170 is formed with the accommodation groove 171 extending along the movement path when the slide door 30 is closed. Therefore, in the vehicle slide door support device 40, the engagement roller 182 naturally enters the accommodation groove 171 as the slide door 30 is closed. That is, even if the second engagement part 180 having the engagement roller 182 is not provided with a component such as a hinge, the vehicle slide door support device 40 may engage the second engagement part 180 with the first engagement part 170 as the slide door 30 is closed.

(6) In the slide door support device 40, once the engagement roller 182 comes into contact with the wall surface of the accommodation groove 171 when entering the accommodation groove 171, the engagement roller 182 rotates in contact with the wall surface of the accommodation groove 171. Therefore, the slide door support device 40 may reduce the resistance caused when the engagement roller 182 enters the accommodation groove 171 as compared with a case where the engagement roller 182 is a non-rotatable engagement body.

(7) For example, assuming a comparative example in which the lower hinge unit 160 has a load roller, when the slide door 30 is closed, there is change from a state where the center of gravity of the slide door 30 is located behind the lower hinge unit 160 to a state where the center of gravity of the slide door 30 is located in front of the lower hinge unit 160. In this case, considering the moment acting on the slide door 30 around the axis extending in the width direction, the direction of the moment changes during the closing operation of the slide door 30. That is, in the comparative example, when the slide door 30 is opened and closed, the slide door 30 is likely to slightly swing around the axis extending in the width direction. Meanwhile, the slide door support device 40 of the present embodiment has no load roller provided in the lower hinge unit 160. Therefore, when the slide door 30 is opened and closed, the swing of the slide door 30 as described above may be suppressed.

### Second Embodiment

In a description of the second embodiment, components common to those of the first embodiment will be designated by the same reference numerals, and a description thereof will be omitted or simplified. Comparing a slide door support device of the second embodiment with the slide door support device of the first embodiment, the configurations of the lower rail and the lower hinge unit are partially different.

As illustrated in FIG. 9, the slide door support device 40A includes a lower rail 130A arranged on the lower portion of the slide door 30, a lower hinge unit 160A arranged below the door opening 21, and a guide unit 190 arranged on the lower portion of the slide door 30. Further, the slide door support device 40A includes the upper rail 110 arranged above the door opening 21, the center rail 120 arranged behind the door opening 21, the upper hinge unit 140 arranged on the upper portion of the slide door 30, and the center hinge unit 150 arranged on the rear portion of the slide door 30, as in the first embodiment. Meanwhile, the slide door support device 40A does not include the first engagement part 170 and the second engagement part 180 according to the first embodiment.

In the present embodiment, the lower rail 130A corresponds to an example of a “first guide rail,” the lower hinge unit 160A corresponds to an example of a “first hinge unit,” the upper rail 110 corresponds to an example of a “second guide rail,” and the upper hinge unit 140 corresponds to an example of a “second hinge unit.”

As illustrated in FIG. 9, the lower rail 130A is arranged inside the slide door 30 in the width direction. For example, the lower rail 130A is arranged between an inner panel 32 and a door trim as components of the slide door 30. The lower rail 130A is curved so as to be directed inward in the width direction with a decreasing distance to the front and then, extends substantially forward. In other words, the lower rail 130A extends rearward and then, is curved so as to be directed outward in the width direction with a decreasing distance to the rear. That is, the lower rail 130A is curved in a manner different from the upper rail 110 and the center rail 120.

The lower rail 130A includes the upper wall 131, the first sidewall 132 extending downward from the inner end in the width direction of the upper wall 131, the second sidewall 133 extending downward from the outer end in the width direction of the upper wall 131, and a top plate 134 covering the rear end of the upper wall 131 from above. In the lower rail 130A, a portion thereof that is not provided with the top plate 134 has a substantially C-shaped cross section orthogonal to the longitudinal direction. The cross-sectional shape of the lower rail 130A orthogonal to the longitudinal direction is open downward.

The top plate 134 has a substantially rectangular plate shape in a plan view in the vertical direction. In the lower rail 130A, when a portion that is curved is called a curved portion CV and a portion that extends straight is a straight portion ST, it can be said that the top plate 134 is provided in the curved portion CV of the lower rail 130A. Further, in a plan view of the lower rail 130A, the length in the transverse direction of the top plate 134 is greater than the length in the transverse direction of the upper wall 131 in the curved portion CV, and the length in the longitudinal direction of the top plate 134 is substantially equal to the length in the longitudinal direction of the upper wall 131 in the curved portion CV. In this way, the top plate 134 protrudes outward in the vehicle width direction from the upper wall 131 in the curved portion CV of the lower rail 130A.

The length in the longitudinal direction of the top plate 134 may be less than the length in the longitudinal direction of the upper wall 131 in the curved portion CV, or may be greater than the length in the longitudinal direction of the upper wall 131 in the curved portion CV. Further, the top plate 134 may be bonded to the upper wall 131 by welding, may be adhered to the upper wall 131 by an adhesive, or may be fastened to the upper wall 131 by a fastening member. Further, the top plate 134 may be bonded to the second sidewall 133.

As illustrated in FIG. 9, the lower hinge unit 160A includes the bracket 161 fixed to the door opening 21, the arm 162 rotatably connected to the bracket 161, the pair of guide rollers 163 rotatably supported by the arm 162, and a second support roller 164 rotatably supported by the arm 162.

In the lower hinge unit 160A, the bracket 161 is fixed behind and below the door opening 21. That is, the bracket 161 is fixed at a position closer to the rear end than the front end of the door opening 21. The arm 162 is connected to the bracket 161 so as to be rotatable around the axis extending in the vertical direction. The pair of guide rollers 163 are arranged side by side in a direction orthogonal to the vertical direction. The rotation axes of the pair of guide rollers 163 extend parallel to the rotation axis of the arm 162. The second support roller 164 is arranged outside the pair of guide rollers 163 in the width direction. The rotation axis of the second support roller 164 is substantially orthogonal to the rotation axes of the pair of guide rollers 163.

In a state where the lower hinge unit 160A is connected to the lower rail 130A, the pair of guide rollers 163 are arranged between the first sidewall 132 and the second sidewall 133 of the lower rail 130A, and the second support roller 164 is arranged outside the second sidewall 133 of the lower rail 130A in the width direction.

When the lower hinge unit 160A moves relative to the lower rail 130A in the longitudinal direction of the lower rail 130A, the pair of guide rollers 163 rotate around the axis extending in the vertical direction in a state of being in contact with the first sidewall 132 or the second sidewall 133.

Meanwhile, when the lower hinge unit 160A moves relative to the curved portion CV of the lower rail 130A in the longitudinal direction of the lower rail 130A, the second support roller 164 comes into contact with the top plate 134 of the lower rail 130A from below. That is, in this case, the second support roller 164 rotates around the axis extending in a direction orthogonal to the second sidewall 133 in a state of being in contact with the top plate 134. Further, when the lower hinge unit 160A moves relative to the straight portion ST of the lower rail 130A in the longitudinal direction of the lower rail 130A, the second support roller 164 does not come into contact with the lower rail 130A. That is, in this case, the second support roller 164 does not rotate.

Then, the upper hinge unit 140 moves in the longitudinal direction with respect to the upper rail 110, the center hinge unit 150 moves in the longitudinal direction with respect to the center rail 120, and the lower rail 130A moves in the longitudinal direction with respect to the lower hinge unit 160A, whereby the slide door 30 is opened and closed.

At this time, the slide door 30 has a first section for movement in the longitudinal direction and a second section for movement in the longitudinal direction as well as movement in the vehicle width direction as a movement section from the fully open position to the fully closed position. The first section is a section from the fully open position to a position near the fully closed position, and the second section is a section from the position near the fully closed position to the fully closed position. The first section may be a section for movement in the slightly width direction as long as the main movement direction of the slide door 30 is the longitudinal direction.

When the slide door 30 is closed from the fully open position, the slide door 30 moves forward in the first section and then, moves, in the second section, in a direction between the forward direction and the direction inward from the width direction. Meanwhile, when the slide door 30 is opened from the fully closed position, the slide door 30 moves, in the second section, in a direction between the rearward direction and the direction outward from the width direction and then, moves, in the first section, rearward of the vehicle. By providing the second section, the slide door 30 may be opened and closed in the longitudinal direction without interfering with the vehicle body 20. Further, the slide door 30 is opened and closed between the fully open position and the fully closed position without being substantially tilted around the axis extending in the vertical direction. In other words, the slide door 30 is opened and closed between the fully open position and the fully closed position while maintaining the posture thereof.

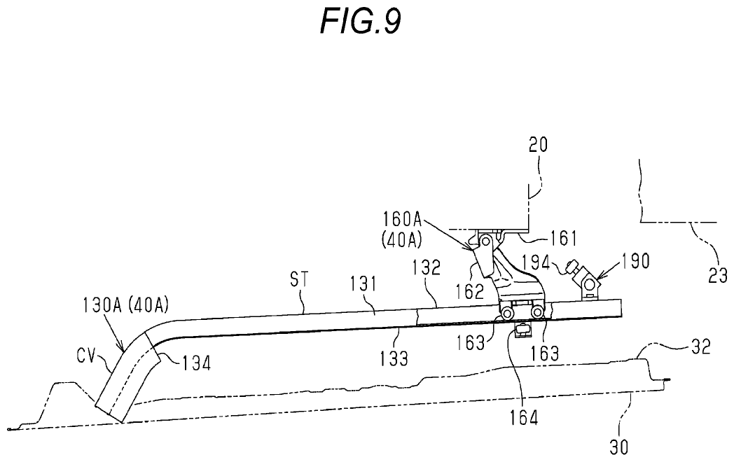

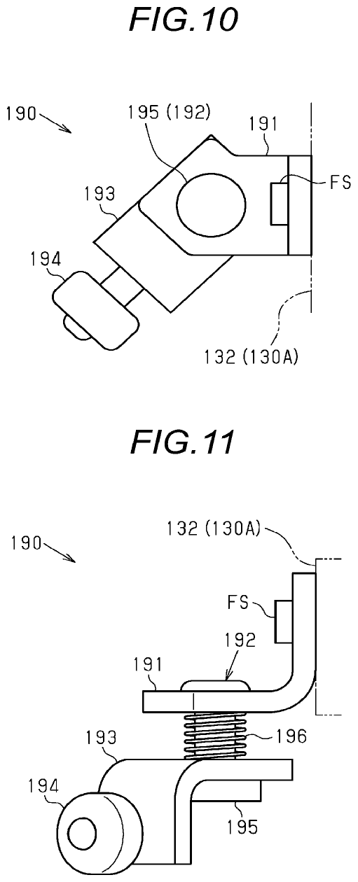

Next, the guide unit 190 will be described with reference to FIGS. 10 and 11.

As illustrated in FIGS. 10 and 11, the guide unit 190 includes a first bracket 191 fixed to the slide door 30, a connector 192 extending downward from the first bracket 191, and a second bracket 193 connected to the first bracket 191 via the connector 192, and a first support roller 194 rotatably supported on the second bracket 193.

Both the first bracket 191 and the second bracket 193 are substantially L-shaped brackets. As illustrated in FIG. 9, the first bracket 191 is fixed to the front end of the first sidewall 132 of the lower rail 130A by a fastening member FS such as a bolt. The first bracket 191 is preferably arranged at a position closer to the front end than the rear end of the slide door 30, and more preferably arranged at a position closer to the front end than a middle portion in the longitudinal direction of the slide door 30. The first bracket 191 may be fixed to the inner panel 32 in addition to the first sidewall 132 of the lower rail 130A, or may be fixed to the door trim according to rigidity thereof.

As illustrated in FIGS. 10 and 11, the connector 192 includes a connection pin 195 that interconnects the first bracket 191 and the second bracket 193 and a biasing member 196 that biases the first bracket 191 and the second bracket 193 in a direction away from each other. The second bracket 193 is movable in the direction in which the axis of the connection pin 195 extends with respect to the first bracket 191 in a state of being connected to the connection pin 195. Further, the second bracket 193 is not rotatable around the axis of the connection pin 195 with respect to the first bracket 191. The biasing member 196 may be an elastic body, for example, a coil spring. The connection pin 195 is inserted through the biasing member 196 between the first bracket 191 and the second bracket 193. Therefore, when the second bracket 193 is displaced in a direction of approaching the first bracket 191, the biasing member 196 is elastically compressed and deformed.

In a state where the guide unit 190 is fixed to the slide door 30, the rotation axis of the first support roller 194 may extend in a direction orthogonal to the movement direction of the slide door 30 in the second section. In other words, in a plan view illustrated in FIG. 9, the rolling direction of the first support roller 194 which is also a direction orthogonal to the rotation axis of the first support roller 194 may be substantially the same as the longitudinal direction of the curved portion CV of the lower rail 130A. Specifically, the rotation axis of the first support roller 194 extends in a direction intersecting both the longitudinal direction and the width direction.

Here, in a case where the movement direction of the slide door 30 is not constant in the second section, when the slide door 30 moves in the second section, the orientation of the first support roller 194 may be determined such that the rotation axis of the first support roller 194 and the movement direction of the slide door 30 intersect each other at an angle close to a right angle for a time period as long as possible.

An operation of the second embodiment will be described.

Specifically, an operation of the lower components of the slide door 30 when the slide door 30 is closed from the fully open position to the fully closed position will be described with reference to FIGS. 9, 12 and 13. In FIGS. 9, 12 and 13, a portion of a floor 23 of the vehicle body 20 is illustrated by a two-dot dash line.

As illustrated in FIG. 9, when the slide door 30 moves in the closing direction in the first section, the lower rail 130A moves forward along the longitudinal direction of the straight portion ST of the lower rail 130A with respect to the pair of guide rollers 163 of the lower hinge unit 160A. At this time, the relative angle between the arm 162 and the bracket 161 of the lower hinge unit 160A is maintained constant.

Further, when the slide door 30 moves in the closing direction in the first section, the first support roller 194 of the guide unit 190 is located outside the floor 23 of the vehicle body 20 in the width direction, and the second support roller 164 of the lower hinge unit 160A is located in front of the top plate 134 of the lower rail 130A. In other words, the first support roller 194 of the guide unit 190 is spaced apart from the floor 23 of the vehicle body 20 in the width direction, and the second support roller 164 of the lower hinge unit 160A is forwardly spaced apart from the top plate 134 of the lower rail 130A. Therefore, the first support roller 194 and the second support roller 164 do not function.

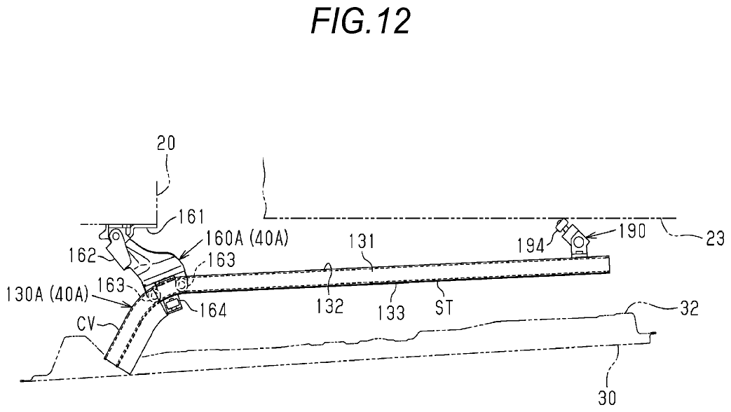

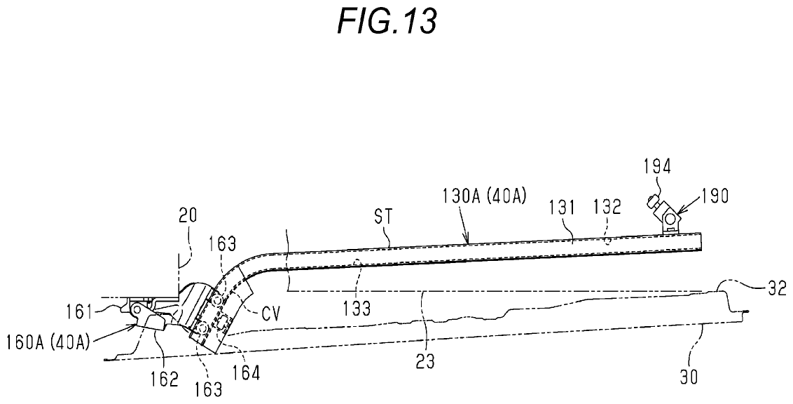

As illustrated in FIGS. 12 and 13, when the slide door 30 moves in the closing direction in the second section, the lower rail 130A moves forward along the longitudinal direction of the curved portion CV of the lower rail 130A with respect to the pair of guide rollers 163 of the lower hinge unit 160A. At this time, the arm 162 of the lower hinge unit 160A rotates with respect to the bracket 161, so that the relative angle between the arm 162 and the bracket 161 changes.

Further, when the slide door 30 moves in the closing direction in the second section, the first support roller 194 of the guide unit 190 rolls on the floor 23 of the vehicle body 20. In other words, the first support roller 194 comes into contact with the floor 23 of the vehicle body 20, so that the front end of the slide door 30 is supported from below. Further, the second support roller 164 of the lower hinge unit 160A rotates in a state of being in contact with the top plate 134 of the lower rail 130A from below. In other words, since the second support roller 164 comes into contact with the top plate 134, so that the rear end of the slide door 30 is supported from below.

In this way, when the slide door 30 moves in the closing direction in the second section, the posture of the slide door 30, particularly, the position of the slide door 30 in the vertical direction is stabilized. Although not described, this is substantially equal to a case where the slide door 30 moves in the opening direction in the second section.

Effects of the second embodiment will be described. In addition to the same effect as the effect (1) of the first embodiment, the second embodiment may obtain the following effects.

(8) In the slide door support device 40A, the first support roller 194 rolls on the floor 23 of the vehicle body 20 when the slide door 30 moves in the second section. Therefore, the slide door support device 40A may suppress the posture of the slide door 30 when the slide door 30 moves in the second section, in other words, the posture of the slide door 30 when the slide door 30 moves near the fully closed position from becoming unstable.

(9) In a case where the first support roller 194 is arranged near the front end of the slide door 30, the distance between the first support roller 194 and the lower hinge unit 160A in the longitudinal direction is increased when the slide door 30 moves in the second section as compared with a case where the first support roller 194 is arranged near the rear end of the slide door 30. That is, the first support roller 194 configured to support the slide door 30 from below and the lower hinge unit 160A may be spaced apart from each other in the longitudinal direction. Therefore, the slide door support device 40A may further suppress the posture of the slide door 30 when the slide door 30 moves in the second section from becoming unstable.

(10) The slide door support device 40A has the biasing member 196 that biases the first support roller 194 downward. Therefore, the slide door support device 40A may easily maintain a state where the first support roller 194 is in contact with the floor 23 when the first support roller 194 rolls on the floor 23 of the vehicle body 20. For example, even if the formation position of the floor 23 of the vehicle body 20 and the fixing position of the first support roller 194 change in the vertical direction, or even if the floor 23 of the vehicle body 20 is uneven, the slide door support device 40A may avoid the situation where the first support roller 194 does not come into contact with the floor 23.

(11) The lower hinge unit 160A has the second support roller 164 that supports the top plate 134 of the lower rail 130A from below. Therefore, the slide door support device 40A may suppress the posture of the slide door 30 in the vertical direction from becoming unstable while the second support roller 164 is in contact with the lower rail 130A.

(12) Since the top plate 134 of the lower rail 130A is provided only on the rear end of the lower rail 130A, the slide door support device 40A may support the lower rail 130A by the second support roller 164 only when the slide door 30 moves in the second section. Accordingly, the slide door support device 40A may suppress the slide door 30 from being excessively restrained due to the second support roller 164 supporting the lower rail 130A when the slide door 30 moves in the first section.

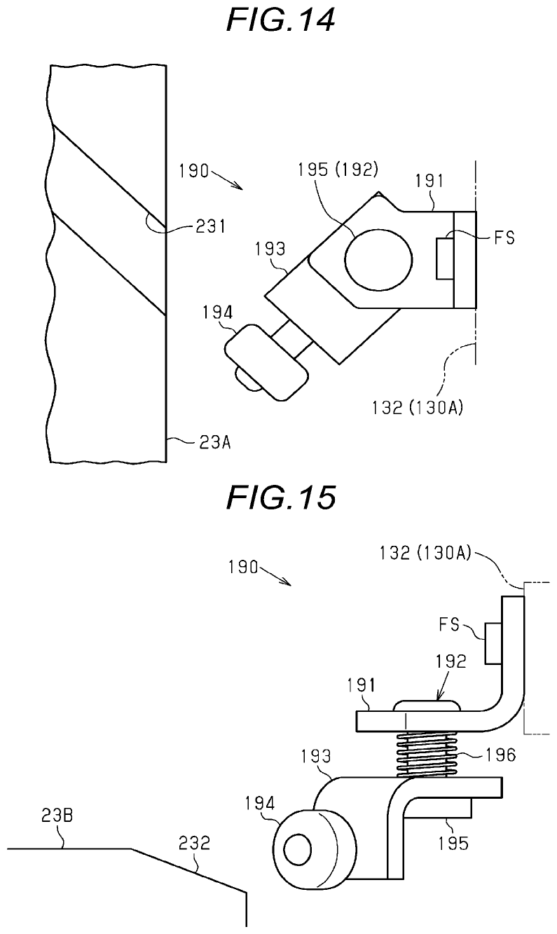

The present embodiments may be modified and implemented as follows. The present embodiments and the following modifications may be implemented in combination with each other within a technically consistent range.
In the slide door support device 40 of the first embodiment, the first engagement part 170 and the second engagement part 180 are not essential components. Also in this case, the slide door support device 40 may obtain the effect (1) of the embodiment.
The slide door support device 40 may not include the upper rail 110 and the upper hinge unit 140, or may not include the center rail 120 and the center hinge unit 150. That is, the slide door support device 40 may include the lower rail 130, the lower hinge unit 160, one guide rail arranged above the lower hinge unit 160 on the vehicle body 20, and one hinge unit arranged above the lower rail 130 on the slide door 30.
In the first embodiment, the slide door support device 40 may have the first engagement part 170 below the door opening 21 and may also have the second engagement part 180 on the lower portion of the slide door 30.
In the first embodiment, the slide door support device 40 may have a plurality of first engagement parts 170 and a plurality of second engagement parts 180.
In the first embodiment, the first engagement part 170 may have a hinge that allows the rod 181 to rotate around the axis extending in the vertical direction with respect to the slide door 30. In this case, the direction in which the accommodation groove for the second engagement part 180 is formed may not need to extend along the movement path of the slide door 30.
In the first embodiment, the engagement roller 182 of the second engagement part 180 may also be a sliding body that slides on the first regulation surface 172 and the second regulation surface 173 of the accommodation groove 171 in the first engagement part 170. In this case, the sliding body corresponds to an example of an “engagement body.”
In the first Embodiment, the engagement mode of the first engagement part 170 and the second engagement part 180 may be changed suitably. For example, the first engagement part 170 may include a recess that is open rearward, and the second engagement part 180 may include a recess that is open forward. In this case, when the slide door 30 is located near the fully closed position, the recess of the first engagement part 170 and the recess of the second engagement part may be engaged with each other so as to interlock each other.
In the first embodiment, when the slide door 30 is closed, the position of the slide door 30 when the first engagement part 170 and the second engagement part 180 start to be engaged with each other may be after the position where the center of gravity of the slide door 30 is located in front of the lower hinge unit 160 in the longitudinal direction. This is because, when the center of gravity of the slide door 30 is located in front of the lower hinge unit 160 in the longitudinal direction, the posture of the slide door 30 is relatively stable even if the first engagement part 170 and the second engagement part 180 are not engaged with each other.
The slide door support devices 40 and 40A may be configured such that the slide door 30 is opened by moving forward and is closed by moving rearward.
The floor 23 of the vehicle body 20 according to the second embodiment may be replaced with a floor 23A illustrated in FIG. 14. Specifically, as illustrated in FIG. 14, the floor 23A according to a first modification has a groove 231 formed along the movement path of the first support roller 194 when the slide door 30 moves in the second section. The width of the groove 231 may be set to correspond to the width of the first support roller 194, and the depth of the groove 231 may be set to correspond to the outer diameter of the first support roller 194.

With this configuration, when the first support roller 194 rolls on the floor 23A, the movement path of the first support roller 194 is stable.

The floor 23 of the vehicle body 20 according to the second embodiment may be replaced with a floor 23B illustrated in FIG. 15. Specifically, as illustrated in FIG. 15, the floor 23B according to a second modification has a slope 232 that is inclined upward and inward in the width direction. The lowermost portion of the slope 232 may be located below the lower surface of the first support roller 194 when the slide door 30 is opened and closed in the first section.

With this configuration, when the first support roller 194 starts to roll on the floor 23B, the first support roller 194 comes into contact with the slope 232. That is, in the modification illustrated in FIG. 15, when the first support roller 194 starts to roll on the floor 23B, it is possible to suppress tapping sound and vibration caused by contact between the first support roller 194 and the floor 23B.
In the second embodiment, a portion of the floor 23 of the vehicle body 20 on which the first support roller 194 rolls may be a floor portion that may be retrofitted. In this case, only the floor portion that may be retrofitted may be easily formed of a material having high rigidity or a material having a low friction coefficient with respect to the first support roller 194. The floor portion that may be retrofitted is, for example, a side sill.
In the second embodiment, the guide unit 190 may not have the biasing member 196. That is, it may be sufficient for the guide unit 190 to have the first support roller 194 that may roll on the floor 23 when the slide door 30 moves in the second section. Also in this case, the effects (8) and (9) of the second embodiment may be obtained.
In the second embodiment, the lower rail 130A may not have the top plate 134, and the lower hinge unit 160A may not have the second support roller 164. Also in this case, the effects (8) to (10) of the second embodiment may be obtained.
In the second embodiment, the top plate 134 of the lower rail 130A may be provided over the longitudinal direction of the upper wall 131 of the lower rail 130A.
In the second embodiment, the lower rail 130A may not have the top plate 134. In this case, the second support roller 164 of the lower hinge unit 160A may be configured to support a wall portion of at least one of the upper wall 131, the first sidewall 132 and the second sidewall 133 of the lower rail 130A from below.
In the second embodiment, the first support roller 194 and the second support roller 164 may not function over the entire second section. In this case, the first support roller 194 and the second support roller 164 may function over a part of the second section close to the fully closed position.
In the second embodiment, a section where the first support roller 194 starts to function and a section where the second support roller 164 starts to function may not match. For example, only one of the first support roller 194 and the second support roller 164 may function in a part of the second section that is closer to the first section, and both the first support roller 194 and the second support roller 164 may function in the remaining part of the second section.
In the second embodiment, the floor 23 of the vehicle body 20 is not limited to a floor on which a seat is provided, and may include a portion lowered one step therefrom.
The vehicle 10 may not include the door actuator 50. That is, the slide door 30 may be a manual slide door instead of an electric slide door.

A vehicle slide door support device according to an aspect of this disclosure connects a slide door to a vehicle body. The slide door is configured to open and close a door opening formed in a side surface of the vehicle body. The device includes a first guide rail arranged on a lower portion of the slide door and regulating a movement direction of the slide door, a first hinge unit arranged below the door opening and configured to move relative to the first guide rail in a longitudinal direction of the first guide rail, a second guide rail arranged above the first hinge unit on the vehicle body and regulating the movement direction of the slide door, and a second hinge unit arranged above the first guide rail on the slide door and configured to move relative to the second guide rail in a longitudinal direction of the second guide rail.

The vehicle slide door support device having the above configuration does not need to include a guide rail below the door opening in respect that the device includes the hinge unit below the door opening and also includes the guide rail on the lower portion of the slide door. Accordingly, the vehicle slide door support device may suppress the region under the floor of a vehicle room from becoming narrow due to any guide rail arranged below the door opening.

In the vehicle slide door support device, it is preferable that the slide door has a first section for movement in a vehicle longitudinal direction and a second section for movement in a vehicle width direction as well as movement in the vehicle longitudinal direction in a section from a fully open position where the door opening is fully opened to a fully closed position where the door opening is fully closed, and the slide door includes a first support roller arranged on the lower portion of the slide door and configured to roll on a floor of the vehicle body when the slide door moves in the second section.

In the vehicle slide door support device having the above configuration, the first support roller rolls on the floor of the vehicle body when the slide door moves in the second section. Therefore, the slide door support device may suppress the posture of the slide door when the slide door moves in the second section, in other words, the posture of the slide door when the slide door moves near the fully closed position from becoming unstable.

In the vehicle slide door support device, it is preferable that the first hinge unit is arranged at a position closer to a rear end than a front end of the door opening, and the first support roller is arranged at a position closer to a front end than a rear end of the slide door.

In a case where the first support roller is arranged near the front end of the slide door, the distance between the first support roller and the first hinge unit in the vehicle longitudinal direction is increased when the slide door moves in the second section as compared with a case where the first support roller is arranged near the rear end of the slide door. Therefore, the vehicle slide door support device having the above configuration can further suppress the posture of the slide door when the slide door moves in the second section from becoming unstable.

In the vehicle slide door support device, it is preferable that the first support roller is biased downward.

In the vehicle slide door support device having the above configuration, the first support roller is likely to remain in contact with the floor of the vehicle body when the first support roller rolls on the floor.

In the vehicle slide door support device, it is preferable that the first hinge unit includes a second support roller configured to support the first guide rail from below.

The vehicle slide door support device having the above configuration can suppress the posture of the slide door in the vehicle vertical direction from becoming unstable while the second support roller supports the first guide rail.

In the vehicle slide door support device, it is preferable that the second support roller supports the first guide rail when the slide door moves in the second section.

The vehicle slide door support device having the above configuration can support the first guide rail by the second support roller only when the slide door moves in the second section. Accordingly, the vehicle slide door support device can suppress the slide door from being excessively restrained due to the second support roller supporting the first guide rail when the slide door moves in the first section.

It is preferable that the vehicle slide door support device further includes a first engagement part arranged on the vehicle body and a second engagement part arranged on the slide door, and the second engagement part is engaged with the first engagement part when the slide door becomes closer to the fully closed position where the door opening is fully closed than the fully open position where the door opening is fully opened.

In a case where the hinge unit is arranged below the door opening and the guide rail is arranged on the lower portion of the slide door, the following problems may occur as compared with a case where the guide rail is arranged below the door opening and the hinge unit is arranged on the lower portion of the slide door. That is, when the slide door is located near the fully closed position, the posture of the slide door may become unstable due to the position of a connection site between the slide door and the vehicle body via the guide rail and the hinge unit.

In this respect, the vehicle slide door support device having the above configuration includes the first engagement part and the second engagement part which are engaged with each other when the slide door is located near the fully closed position. Therefore, the vehicle slide door support device may suppress the posture of the slide door from becoming unstable when the slide door is located near the fully closed position in respect that the number of connection sites between the vehicle body and the slide door is increased by the first engagement part and the second engagement part.

In the vehicle slide door support device, it is preferable that the second guide rail and the first engagement part are arranged above the door opening, and the second hinge unit and the second engagement part are arranged at a distance in the vehicle longitudinal direction on an upper portion of the slide door.

The vehicle slide door support device having the above configuration may suppress the space under the floor of the vehicle room from becoming narrow in respect that the first engagement part is not arranged below the door opening. Further, since the second hinge unit and the second engagement part are arranged at a distance in the vehicle longitudinal direction, the posture of the slide door is further suppressed from becoming unstable when the slide door is located near the fully closed position as compared with a case where the second hinge unit and the second engagement part are arranged close to each other in the vehicle longitudinal direction.

In the vehicle slide door support device, it is preferable that the first engagement part is formed with an accommodation groove extending along a movement path of the slide door when the slide door is closed, and the second engagement part has an engagement body configured to enter the accommodation groove and be engaged with the accommodation groove when the slide door is closed.

In the vehicle slide door support device having the above configuration, the engagement body naturally enters the accommodation groove as the slide door is closed. That is, the vehicle slide door support device may engage the second engagement part with the first engagement part as the slide door is closed.

In the vehicle slide door support device, it is preferable that the engagement body is an engagement roller configured to rotate around an axis extending in a direction orthogonal to a direction in which the engagement roller enters the accommodation groove.

In the vehicle slide door support device having the above-described configuration, when the engagement body comes into contact with the wall surface of the accommodation groove when entering the accommodation groove, the engagement roller in contact the wall surface of the accommodation groove rotates. Therefore, the vehicle slide door support device may reduce the resistance caused when the engagement body enters the accommodation groove.

According to the above-described vehicle slide door support device, it is possible to suppress the region under the floor of the vehicle compartment from becoming narrow.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle slide door support device that connects a slide door to a vehicle body, the slide door being configured to open and close a door opening formed in a side surface of the vehicle body, the device comprising:
a first guide rail arranged on a lower portion of the slide door and regulating a movement direction of the slide door;
a first hinge unit arranged below the door opening and configured to move relative to the first guide rail in a longitudinal direction of the first guide rail;
a second guide rail arranged above the first hinge unit on the vehicle body and regulating the movement direction of the slide door; and
a second hinge unit arranged above the first guide rail on the slide door and configured to move relative to the second guide rail in a longitudinal direction of the second guide rail.

2. The vehicle slide door support device according to claim 1, wherein
the slide door has a first section for movement in a vehicle longitudinal direction and a second section for movement in a vehicle width direction as well as movement for the vehicle longitudinal direction in a section from a fully open position where the door opening is fully opened to a fully closed position where the door opening is fully closed, and
the slide door includes a first support roller arranged on the lower portion of the slide door and configured to roll on a floor of the vehicle body when the slide door moves in the second section.

3. The vehicle slide door support device according to claim 2, wherein
the first hinge unit is arranged at a position closer to a rear end than a front end of the door opening, and
the first support roller is arranged at a position closer to a front end than a rear end of the slide door.

4. The vehicle slide door support device according to claim 2, wherein
the first support roller is biased downward.

5. The vehicle slide door support device according to claim 2, wherein
the first hinge unit includes a second support roller configured to support the first guide rail from below.

6. The vehicle slide door support device according to claim 5, wherein
the second support roller supports the first guide rail when the slide door moves in the second section.

7. The vehicle slide door support device according to claim 1, further comprising:
a first engagement part arranged on the vehicle body; and
a second engagement part arranged on the slide door, wherein
the second engagement part is engaged with the first engagement part when the slide door becomes closer to the fully closed position where the door opening is fully closed than the fully open position where the door opening is fully opened.

8. The vehicle slide door support device according to claim 7, wherein
the second guide rail and the first engagement part are arranged above the door opening, and
the second hinge unit and the second engagement part are arranged at a distance in the vehicle longitudinal direction on an upper portion of the slide door.

9. The vehicle slide door support device according to claim 8, wherein
the first engagement part is formed with an accommodation groove extending along a movement path of the slide door when the slide door is closed, and
the second engagement part has an engagement body configured to enter the accommodation groove and be engaged with the accommodation groove when the slide door is closed.

10. The vehicle slide door support device according to claim 9, wherein
the engagement body is an engagement roller configured to rotate around an axis extending in a direction orthogonal to a direction in which the engagement roller enters the accommodation groove.
